(19) United States
(12) Patent Application Publication
(10) Pub. No.: US 2025/0300474 A1
(43) Pub. Date: Sep. 25, 2025

(54) TRANSISTOR PROTECTION FOR BATTERY PACKS

(71) Applicant: Qorvo US, Inc., Greensboro, NC (US)

(72) Inventors: Jeremy Kuehlwein, Woodbury, MN (US); John H. Carpenter, JR., Melbourne, FL (US)

(21) Appl. No.: 18/983,525

(22) Filed: Dec. 17, 2024

Related U.S. Application Data
(60) Provisional application No. 63/568,240, filed on Mar. 21, 2024.

(51) Int. Cl. H02J 7/00

(52) U.S. Cl. CPC H02J 7/0071; H02J 7/0063; H02J 7/0068

(57) ABSTRACT

Systems and methods for transistor protection for battery packs are disclosed. In one aspect, transistors are turned on and off at a duty cycle selected to keep the transistor in a safe operating area (SOA). Such SOAs are generally defined by voltage, current, and time, so by keeping the time limited, high currents or voltages may be better tolerated. In specifically contemplated aspects, a control circuit alternately activates and deactivates driver transistors to toggle a discharge pin, thereby setting the duty cycle.

### PRIORITY APPLICATION

The present application claims priority to U.S. Provisional Patent Application Ser. No. 63/568,240, filed on Mar. 21, 2024, and entitled “TRANSISTOR PROTECTION FOR BATTERY PACKS,” the contents of which are incorporated herein by reference in its entirety.

### BACKGROUND

### I. Field of the Disclosure

The technology of the disclosure relates generally to techniques to assist in keeping external charging transistors for battery packs in a safe area of operation.

### II. Background

Battery-operated devices abound in modern society. In many cases, the batteries may be rechargeable. Such rechargeable batteries typically have a circuit that monitors battery discharge current as well as battery charging current (i.e., current flow in/out of the battery). This circuit usually includes one or more external transistors that act as protection devices. These transistors have safe operating areas (SOA). When operating conditions exit the SOA (e.g., having a high current and a concurrent high voltage), these external transistors may be damaged. In extreme cases, the damage may render the rechargeable battery non-operational and require the replacement of the entire apparatus. Finding ways to protect these external transistors provides room for innovation.

### SUMMARY

Aspects disclosed in the detailed description include transistor protection for battery packs. In particular, aspects of the present disclosure contemplate turning on and off external transistors for the battery pack at a duty cycle selected to keep the transistor in a safe area of operation. Such safe areas are generally defined by voltage, current, and time, so by keeping the time limited, high currents or voltages may be better tolerated. In specifically contemplated aspects, a control circuit alternately activates and deactivates driver transistors to toggle a discharge pin, thereby setting the duty cycle.

In this regard, in one aspect, a battery pack control circuit is disclosed. The battery pack control circuit includes a discharge pin configured to be coupled to an external transistor and a precharge control circuit configured to toggle the discharge pin between an output node voltage and a battery node voltage at a duty cycle weighted to prevent the external transistor from exiting a safe operating area (SOA).

In another aspect, a battery pack is disclosed. The battery pack includes a discharge transistor coupled to an external voltage node and a control circuit comprising a discharge pin configured to be coupled to the discharge transistor. The control circuit also comprising a precharge control circuit configured to toggle the discharge pin between an output node voltage and a battery node voltage at a duty cycle weighted to prevent the discharge transistor from exiting an SOA.

In another aspect, a method of controlling a battery pack is disclosed. The method includes toggling a discharge pin between an output node voltage and a battery node voltage at a duty cycle weighted to prevent a discharge transistor from exiting an SOA.

### BRIEF DESCRIPTION OF THE DRAWINGS

FIG. 1 is a block diagram of a system having a rechargeable battery pack;

FIG. 2 is a block diagram of a portion of the rechargeable battery pack showing where transistors can be found in the charge and discharge path of the rechargeable battery pack;

FIG. 3 is a block diagram of a portion of the control circuit in the rechargeable battery pack that toggles the transistor according to aspects of the present disclosure;

FIG. 4 is a flowchart illustrating an exemplary process for protecting transistors in the charge and discharge path; and

FIG. 5 is a graph showing an exemplary voltage level for the transistors in the rechargeable battery pack as a result of using the process of FIG. 4.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element, or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

To the extent that the term “approximately” is used in the claims, it is herein defined to be within five percent (5%).

Aspects disclosed in the detailed description include transistor protection for battery packs. In particular, aspects of the present disclosure contemplate turning on and off external transistors for the battery pack at a duty cycle selected to keep the transistor in a safe area of operation. Such safe areas are generally defined by voltage, current, and time, so by keeping the time limited, high currents or voltages may be better tolerated. In specifically contemplated aspects, a control circuit alternately activates and deactivates driver transistors to toggle a discharge pin, thereby setting the duty cycle.

More specifically, aspects of the present disclosure are well suited for use with rechargeable battery packs for end use devices having battery voltage levels greater than twelve volts, such as garden tools, power tools, e-bikes, hoverboards, or the like. Within these rechargeable battery packs, there are a variety of safety mechanisms designed to protect battery elements. While the ultimate fail-safe is a fuse, there are also charging and discharging transistors that assist in protecting the device during charging and discharging events. These transistors have safe areas of operation defined by voltage, current, and time. When the transistors operate outside the safe areas of operation, the transistors may fail, which may result in damage to the battery elements if the fuse also fails. Even if the fuse operates as intended, the failure of the transistors may compromise the operation of the battery pack until such time as the transistors are replaced.

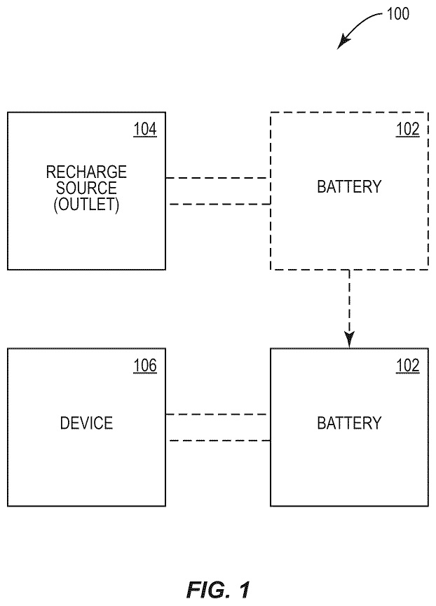

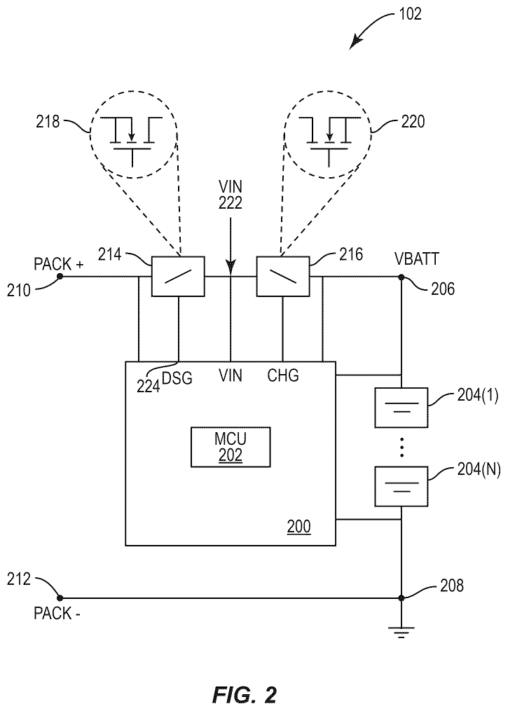

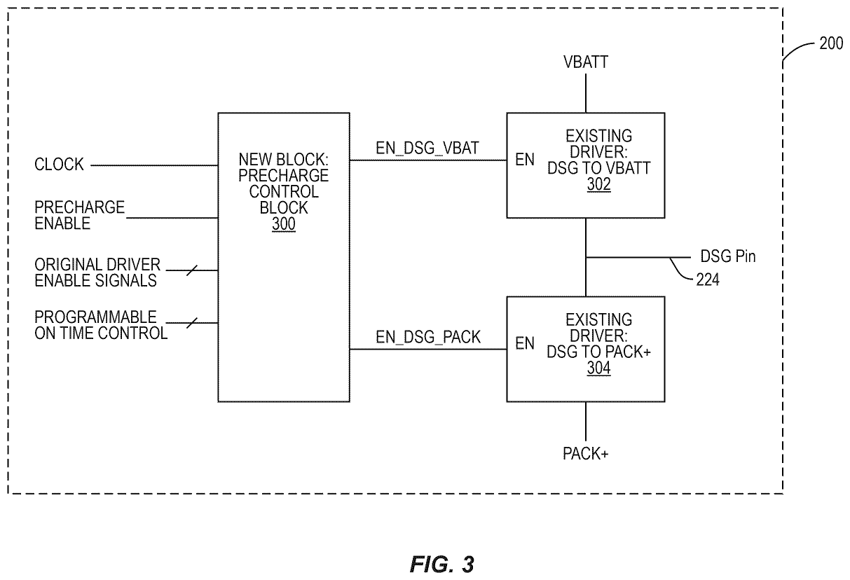

Before addressing aspects of the present disclosure, a brief overview of a battery pack system where transistors are used and the risks to which these transistors are exposed is provided with reference to FIGS. 1 and 2. A discussion of aspects of the present disclosure begins below with reference to FIG. 3.

In this regard, FIG. 1 provides a simplified diagram of a system 100 where a battery pack 102 is selectively moved between a recharge source 104 and an end use device 106. The recharge source 104 may be an outlet, a docking station plugged into an outlet, or the like. The battery pack 102 is configured to couple to the recharge source 104 and the end use device 106. As noted above, a typical end use device 106 may be a garden tool, an e-bike, a hoverboard, or other comparatively high-power (i.e., over twelve volts) device that uses a rechargeable battery element.

FIG. 2 provides additional details about the battery pack 102. A control circuit 200 may include a microcontroller unit (MCU) 202. A conventional control circuit 200 may be the PAC25140 sold by Qorvo US, Inc. the assignee of the present disclosure. For additional information about such a conventional control circuit, the interested reader is directed to https://www.qorvo.com/products/p/PAC25140, where a data sheet may be retrieved.

A plurality of battery elements 204(1)-204(N) cumulatively provide a battery signal Vbatt at a node 206 and are coupled to ground at node 208. The battery elements 204(1)-204(N) are external to the control circuit 200 and may be monitored by the control circuit 200. The battery pack 102 also includes a positive node 210 (PACK+) and a negative node 212 (PACK−), which are used to couple to the recharge source 104 and the end use device 106. When charging the battery elements 204(1)-204(N), the control circuit 200 opens a discharge (DSG) switch 214 and closes a charge (CHG) switch 216. The switches 214, 216 are external to the control circuit 200 and may, for example, be N-type field effect transistors (NFETs) 218, 220 respectively with a node 222 (Vin) therebetween. The voltage Vin at node 222 is, by virtue of the diode within the NFET 220, held at one diode's voltage drop below Vbatt.

When discharging the battery elements 204(1)-204(N) (e.g., powering a garden tool), the control circuit 200 closes the DSG switch 214 and opens the CHG switch 216. Even when a switch is open, an internal diode (not shown) is present that allows current to flow from the node 206 to the node 210 and vice versa. It should be appreciated that the NFETs 218, 220 and particularly the NFET 218 that forms the DSG switch 214 may have or be a large capacitive load.

The NFETs 218, 220 have a safe operating area (SOA) that is defined by voltage, current, and time. That is, high voltages or high currents may be tolerated for short periods of time before the NFETs 218, 220 fail. Likewise, a mixture of moderate current and moderate voltage may be tolerated for short periods of time, but the combinations of high current or high voltage for longer periods of time may result in device failure. Such high current situations may occur when the battery elements 204(1)-204(N) are charged, the NFETs 218, 220 are off, and the capacitive load at the node 210 is discharged down to a low voltage. In such cases, the NFET 218 may have a large voltage across the NFET 218 with a source coupled to the node 210 at a low voltage (PACK+) and a drain coupled to the node 222 at relatively high Vin. When the control circuit 200 closes the DSG switch 214 by turning on the NFET 218, the load voltage (PACK+) will remain at a low voltage for a long time due to the large capacitance of the NFET 218. However, there is a large current flowing through the NFET 218 coupled with the high voltage, which can push the NFET 218 out of the SOA.

In the past, there have been at least two solutions, both of which add a pin to the control circuit and/or include a number of additional board-level components, increasing cost and consuming space. Both cost and space are premiums in many designs, and accordingly, the increase in cost and/or space is undesirable.

Aspects of the present disclosure contemplate using a precharge control circuit 300 in the control circuit 200, as better illustrated in FIG. 3. The precharge control circuit 300 uses drivers 302 and 304 to control the signal on a DSG pin 224 (see also FIG. 2) that couples to the gate of the NFET 218 to turn the NFET 218 on or off, thereby controlling how long the NFET 218 is on. More specifically, when the load voltage at the node 210 is low and the capacitance of the NFET 218 is discharged, the precharge control circuit 300 may toggle the NFET 218 on and off in a predetermined duty cycle that limits how long the NFET 218 is exposed to a large voltage and current. In an exemplary aspect, the duty cycle is usefully below fifty percent and in more specific examples may be below ten percent. By controlling when and for how long the NFET 218 is on, the precharge control circuit 300 may effectively stair-step the charge on the NFET 218 while keeping the NFET 218 in the SOA until the NFET 218 has a sufficient charge that the difference in the voltage at node 210 and the node 222 is sufficiently small to avoid the risk of damage to the NFET 218.

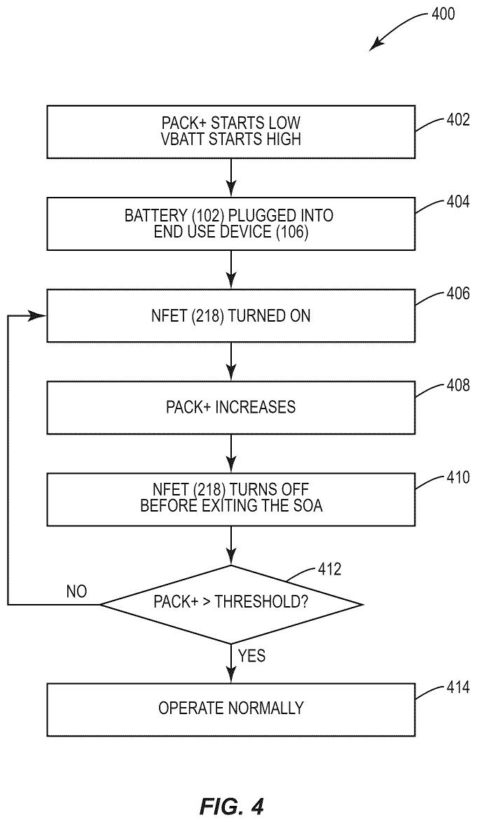

With continued reference to FIG. 3, the precharge control circuit 300 may receive a clock signal, which in some aspects may be used to determine when the NFET 218 should be toggled on or off. The precharge control circuit 300 may also receive a precharge enable signal from the control circuit 200. The precharge enable signal activates the use of the precharge process 400 set forth below in the description of FIG. 4. Additionally, the precharge control circuit 300 may receive original driver enable signals, which may be activated after the precharge enable signal has been deactivated and function to control the drivers 302, 304 during normal operation. Likewise, programmable ON time control signals may allow the MCU 202 to dictate the duty cycle for toggling the NFET 218.

With continued reference to FIG. 3, it should be appreciated that only one of the drivers 302 or 304 would be active at one time. Accordingly, the precharge control circuit 300 may have programming or circuits that preclude concurrent activation of the drivers 302, 304. The driver 302 may be coupled to the Vbatt voltage at the node 206 and selectively allow that voltage to be provided over the DSG pin 224 when the driver 302 is active. Similarly, the driver 304 may be coupled to the PACK+ voltage at the node 210 and selectively allow that voltage to be provided over the DSG pin 224 when the driver 304 is active.

It should be appreciated that this approach does not require any additional pins for the control circuit 200, or additional external devices. Accordingly, space and cost are conserved. Further, since the original equipment manufacturer (OEM) may select the NFETs 218, 220, the programmability of the precharge control circuit 300 allows the OEM to select duty cycles responsive to different SOA characteristics.

Instead of using the precharge control circuit 300, aspects of the present disclosure could be implemented through software operating on the MCU 202.

Relevantly, the DSG pin 224 is toggled high (i.e., turning on the NFET 218 with DSG pin 224 pulled to Vbatt) and low (i.e., turning off the NFET 218 with DSG pin 224 pulled to PACK+) in a pulse width modulation (PWM) fashion. Thus, the NFET 218 will charge the node 210 during the ON time and hold the node 210 at the charged voltage during OFF time. By limiting ON time, heat may dissipate, keeping the NFET 218 in the SOA.

In one implementation (not specifically illustrated) for the precharge control circuit 300, a capacitor is discharged at a frequency determined by the input clock and then charged using a programmable digital-to-analog converter (DAC). The capacitor voltage along with a reference comparator is fed into a comparator. EN_DS_VBAT=1 while the capacitor voltage is higher than the reference voltage. During the charging, the capacitor voltage crosses the reference threshold at some point and trips the comparator, causing EN_DS_VBAT to go low. By using a programmable DAC to charge the capacitor, a programmable ON time for EN_DS_VBAT is created. This example is provided to show possession of a working example and is not intended to be limiting.

More generically, the process 400, illustrated in FIG. 4 begins with PACK+ starting low and Vbatt starting high (block 402) such as when a battery pack 102 is freshly charged. The battery pack 102 is plugged into an end use device 106 (block 404). The NFET 218 is turned on (block 406), such as by the precharge control circuit 300 or software in the MCU 202. While NFET 218 is ON, PACK+ increases (block 408). The NFET 218 is then turned off before the NFET 218 exits the SOA (block 410). The NFET 218 is held at the new PACK+ level, and it is determined if PACK+ exceeds a desired operating threshold (block 412). If the answer to block 412 is no, the process 400 iterates as shown. Otherwise, if the answer to block 412 is yes, then normal operation may begin (block 414).

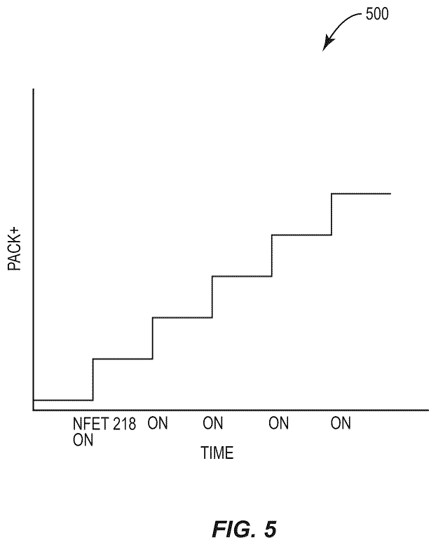

Implementing the process 400 results in a graph 500 shown in FIG. 5, where PACK+ is plotted against time. PACK+ increases during the short windows that the NFET 218 is ON. Again, this ON window for the NFET 218 is designed to be short enough to avoid exiting the SOA and the OFF window is long enough to allow heat to dissipate or otherwise allow the NFET 218 to recover from the short high voltage, high current ON window. Thus, the duty cycle is chosen with this recovery in mind.

It is noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A battery pack control circuit comprising:
a discharge pin configured to be coupled to an external transistor;
a precharge control circuit configured to:
toggle the discharge pin between an output node voltage and a battery node voltage at a duty cycle weighted to prevent the external transistor from exiting a safe operating area (SOA).

2. The battery pack control circuit of claim 1, further comprising a first driver circuit and a second driver circuit, the first driver circuit configured to pull the discharge pin to the output node voltage and the second driver circuit configured to pull the discharge pin to the battery node voltage.

3. The battery pack control circuit of claim 2, wherein the precharge control circuit is coupled to the first driver circuit and the second driver circuit and configured to activate only one or the other of the first and second driver circuits at any given time.

4. The battery pack control circuit of claim 1, wherein the precharge control circuit is configured to stair-step up a voltage level at the discharge pin from a low value to a value approximating the battery node voltage.

5. The battery pack control circuit of claim 1, wherein the precharge control circuit comprises a microprocessor with associated software.

6. The battery pack control circuit of claim 1, wherein the precharge control circuit is configured to set the duty cycle based on an external clock signal.

7. The battery pack control circuit of claim 1, wherein the duty cycle is less than 10 percent.

8. A battery pack comprising:
a discharge transistor coupled to an external voltage node;
a control circuit comprising:
a discharge pin configured to be coupled to the discharge transistor;
a precharge control circuit configured to:
toggle the discharge pin between an output node voltage and a battery node voltage at a duty cycle weighted to prevent the discharge transistor from exiting a safe operating area (SOA).

9. The battery pack of claim 8, wherein the discharge transistor comprises an n-type field effect transistor, NFET.

10. The battery pack of claim 9, wherein the discharge pin couples to a gate of the NFET.

11. The battery pack of claim 8, further comprising a battery element coupled to the battery node voltage.

12. The battery pack of claim 8, wherein the duty cycle is less than 10 percent.

13. The battery pack of claim 8, further comprising a first driver circuit and a second driver circuit, the first driver circuit configured to pull the discharge pin to the output node voltage and the second driver circuit configured to pull the discharge pin to the battery node voltage.

14. The battery pack of claim 8, wherein the precharge control circuit is configured to stair-step up a voltage level at the external voltage node from a low value to a value approximating the battery node voltage.

15. A method of controlling a battery pack comprising:
toggling a discharge pin between an output node voltage and a battery node voltage at a duty cycle weighted to prevent a discharge transistor from exiting a safe operating area (SOA).

16. The method of claim 15, wherein toggling the discharge pin comprises using drivers to turn couple the discharge pin to the output node voltage and the battery node voltage.

17. The method of claim 15, wherein toggling the discharge pin causes a voltage at an external voltage node from a low value to a value approximating the battery node voltage through a stair-step process.

18. The method of claim 15, wherein the output node voltage is initially lower than the battery node voltage.

19. The method of claim 15, wherein the duty cycle is less than 10 percent.

20. The method of claim 15, further comprising using a microcontroller and software to control the toggling.
